(19) United States
(12) Patent Application Publication
(10) Pub. No.: US 2021/0181056 A1
(43) Pub. Date: Jun. 17, 2021

(54) METHOD FOR DETERMINING TEMPERATURE-INDUCED SAG VARIATION OF MAIN CABLE AND TOWER-TOP HORIZONTAL DISPLACEMENT OF SUSPENSION BRIDGES

(71) Applicant: University of Science and Technology Beijing, Beijing (CN)

(72) Inventor: Yi ZHOU, Beijing (CN)

(73) Assignee: University of Science and Technology Beijing, Beijing (CN)

(21) Appl. No.: 16/790,689

(22) Filed: Feb. 13, 2020

(30) Foreign Application Priority Data
Dec. 16, 2019 (CN) 201911299463.1

(51) Int. Cl. G01M 5/00; G01L 5/102; G01K 13/04; G01K 3/12

(52) U.S. Cl. CPC G01M 5/0008; G01L 5/102; E01D 11/02; G01K 3/12; G01K 13/04

(57) ABSTRACT

A method for determining the temperature-induced sag variation of the main cable and the tower-top horizontal displacement of suspension bridges takes the sag variation and the span variation of each span of the main cable as the unknown quantities. By using the horizontal tension equilibrium at the tower top, the geometric relationship between the shape and the length of the main cable, and the compatibility condition to be satisfied by the sum of spans of each span of the main cable, a linear system of equations is constructed. The linear system of equations is solved to obtain the temperature-induced sag variation of the main cable and the tower-top horizontal displacement of the suspension bridge. This method can be extended to the temperature deformation analysis of the other cable systems with any number of spans such as transmission lines, ropeways, and the like.

### CROSS REFERENCE TO THE RELATED APPLICATIONS

This application is based upon and claims priority to Chinese Patent Application No. 201911299463.1, filed on Dec. 16, 2019, the entire contents of which are incorporated herein by reference.

### TECHNICAL FIELD

The present disclosure relates to the technical field of analysis and monitoring of bridge structures, and more particularly directed to a method for determining the variations in the main cable sag and tower-top horizontal displacement of suspension bridges with the ambient temperature changes.

### BACKGROUND

Structural health monitoring systems in suspension bridges usually focus on the global deformation of the main cable, which can be characterized by the sag change of the main cable and the horizontal displacement of the tower top. Field measurement has shown that the shape of the main cable of a suspension bridge varies significantly with the variation of ambient temperature. The temperature-induced deformation can unfavorably mask abnormal deformations of the bridge structure caused by structural damage or degradation, and it needs to be excluded from the measured total deformation in order to highlight the abnormal deformation and subsequently evaluate the structural condition more accurately. Therefore, it is imperative to study the relationship between the temperature changes and the sag variation of the main cable and the horizontal displacement of the tower top of suspension bridges.

At present, the methods for calculating the temperature deformation of suspension bridges include: (1) regression analysis; (2) finite element analysis; and (3) physics-based formulas. The regression analysis does not reflect the causal relationship between the variables, and the obtained model is dedicated to specific bridges, which has poor generality. The finite element analysis requires detailed design information and necessary expertise, and as being case by case, a separate model is required for different bridges. In spite of an approximate estimate, the physics-based formulas have merits of clear concepts, general applicability, and great convenience for parametric analysis and field calculation, thus making it more advantageous than the other two methods. However, the physics-based formulas for the temperature deformation of suspension bridges are few and imperfect at best. The sag variation of the main-span cable is calculated by either the single-span cable model, or simplified formulas with ignorance of the sag effect of the side span cables, while the calculation formula of the tower-top horizontal displacement is even rarely reported.

### SUMMARY

The objective of the present disclosure is to provide a method for determining the temperature-induced sag variation of the main cable and the tower-top horizontal displacement of suspension bridges.

The present disclosure first provides a calculation method for the temperature-induced variation in the main cable sag and the tower-top horizontal displacement of the two-tower ground-anchored suspension bridge, and then extends the calculation method to the self-anchored suspension bridge as well as other cable systems with any number of spans. The calculation process for the temperature deformation of the two-tower ground-anchored suspension bridge is as follows:

(1) according to the equilibrium condition that the horizontal tensions of the main cable on both sides of the tower top are always equal, establishing the following equation:

$$\frac{δ {f}_{i}}{{f}_{i}} - \frac{δ {l}_{i}}{{l}_{i}} = \frac{δ {f}_{i + 1}}{{f}_{i + 1}} - \frac{δ {l}_{i + 1}}{{l}_{i + 1}}$$

where i=1, 2; fᵢ is a sag (or mid-span deflection) of an i^{th} span main cable; δfᵢ is a variation of fᵢ caused by a temperature variation; lᵢ is a span (horizontal distance of supports at both ends) of the i^{th} span main cable; δlᵢ is a variation of lᵢ caused by the temperature variation; subscripts 1, 2, 3 of variables indicate a left side span, a main span, and a right side span, respectively;

(2) according to a geometric relationship between a shape and a length of the main cable, establishing the following equation:

$$\frac{{c}_{ni}}{{l}_{i}} \cdot δ {f}_{i} - \frac{{c}_{ni} \cdot {n}_{i}}{{l}_{i}} \cdot δ {l}_{i} + {c}_{li} \cdot δ {l}_{i} - \frac{{c}_{α i} \cdot sin 2 {α}_{i}}{2 \cdot {l}_{i}} \cdot δ {l}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} )$$

where i=1, 2, 3; nᵢ is a sag-to-span ratio of the i^{th} span main cable, i.e. nᵢ=fᵢ/lᵢ; αᵢ is a chord inclination (positive for a counterclockwise rotation from a horizontal line) of the i^{th} span main cable; coefficients cₙᵢ, cₗᵢ, and c_{αi} are respectively:

$${c}_{ni} = {l}_{i} \cdot [ \frac{16}{3} {n}_{i} {cos}^{3} {α}_{i} - \frac{128}{5} {n}_{i}^{3} ( 5 {cos}^{7} {α}_{i} - 4 {cos}^{5} {α}_{i} ) ]$$

$${c}_{li} = sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} )$$

$${c}_{α i} = {l}_{i} \cdot [ \frac{sin {α}_{i}}{{cos}^{2} {α}_{i}} - 8 {n}_{i}^{2} sin {α}_{i} {cos}^{2} {α}_{i} + 32 {n}_{i}^{4} {cos}^{4} {α}_{i} sin {α}_{i} ( 7 {cos}^{2} {α}_{i} - 4 ) ]$$

δSᵢ is a length variation of the i^{th} span main cable caused by the temperature variation; δh_{Pi} and δh_{P(i-1)} are an elevation change of the support points i and i=1 of the main cable, respectively, and δh_{P0}=δh_{P3}=0;

δSᵢ (i=1, 2, 3) and δh_{Pi} (i=1, 2) are estimated by the following equations:

$$δ {S}_{i} = {S}_{i} \cdot {θ}_{C} \cdot δ {T}_{C} = {l}_{i} \cdot {θ}_{C} \cdot δ {T}_{C} [ sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ]$$

$$δ {h}_{Pi} = {h}_{Pi} \cdot {θ}_{P} \cdot δ {T}_{P}$$

where θ_{C} is a linear expansion coefficient of the main cable, θ_{P} is a linear expansion coefficient of a tower of the suspension bridge, δT_{C} is a temperature variation of the main cable, δT_{P} is a temperature variation of the tower of the suspension bridge, and h_{Pi} is a height of the tower of the suspension bridge;

(3) according to a compatibility condition to be satisfied by a sum of spans of a left side span cable, a main span cable, and a right side span cable, that is, the distance between the anchorages at both ends is constant, establishing the following equation:

$${\sum }_{i = 1}^{3} δ {l}_{i} = 0 ;$$

(4) according to the following linear system of equations consisting of the equations in steps (1), (2), and (3), simultaneously obtaining the sag variation δfᵢ and the span variation δlᵢ of the left side span cable, the main span cable, and the right side span cable:

$$[ \begin{matrix}- \frac{1}{{f}_{1}} & \frac{1}{{f}_{2}} & 0 & \frac{1}{{l}_{1}} & - \frac{1}{{l}_{2}} & 0 \\ 0 & - \frac{1}{{f}_{2}} & \frac{1}{{f}_{3}} & 0 & \frac{1}{{l}_{2}} & - \frac{1}{{l}_{3}} \\ 0 & 0 & 0 & 1 & 1 & 1 \\ \frac{{c}_{n 1}}{{l}_{1}} & 0 & 0 & {M}_{1} & 0 & 0 \\ 0 & \frac{{c}_{n 2}}{{l}_{2}} & 0 & 0 & {M}_{2} & 0 \\ 0 & 0 & \frac{{c}_{n 3}}{{l}_{3}} & 0 & 0 & {M}_{3}\end{matrix} ] \cdot [ \begin{matrix}δ {f}_{1} \\ δ {f}_{2} \\ δ {f}_{3} \\ δ {l}_{1} \\ δ {l}_{2} \\ δ {l}_{3}\end{matrix} ] = [ \begin{matrix}0 \\ 0 \\ 0 \\ {Δ}_{1} \\ {Δ}_{2} \\ {Δ}_{3}\end{matrix} ] where$$

$${M}_{i} = - \frac{{c}_{ni} \cdot {n}_{i}}{{l}_{i}} + {c}_{li} - \frac{{c}_{α i} \cdot sin 2 {α}_{i}}{2 \cdot {l}_{i}} , \\ {Δ}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} ) , \\ i = 1 , 2 , 3.$$

The tower-top horizontal displacement of the left tower and the right tower are δlᵢ and δl₃, respectively (positive for a movement toward the main span), and a horizontal distance variation between the tower top of the left tower and the tower top of the right tower is δl₂.

When the higher-order terms of the sag-to-span ratio nᵢ in the coefficients cₙᵢ, cₗᵢ, and c_{αi} are ignored (nᵢ of a suspension bridge is generally between 1/12 and 1/9), the analytical solutions of the sag variation δfᵢ and the span variation δlᵢ of the i^{th} span main cable are respectively:

$$δ {f}_{i} = \frac{{n}_{i}}{cos {α}_{i}} δ {S}_{i} - {n}_{i} tan {α}_{i} ( δ {h}_{Pi} - δ {h}_{P ( i - 1 )} ) + \frac{{n}_{i} ( 3 {l}_{i} - 16 {r}_{i} )}{16 \cdot {\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} - tan {α}_{k} ) \cdot δ {h}_{Pk} ]$$

$$δ {l}_{i} = \frac{δ {S}_{i}}{cos {α}_{i}} - tan {α}_{i} ( δ {h}_{Pi} - δ {h}_{P ( i - 1 )} ) - \frac{{r}_{i}}{{\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} - tan {α}_{k} ) \cdot δ {h}_{Pk} ]$$

where rᵢ=lᵢ·nᵢ²·cos²αᵢ (i=1, 2, 3), rⱼ=lⱼ·nⱼ²·cos²αⱼ (j=1, 2, 3), and i, j, and k are all subscripts.

When the tower-top elevations of the left tower and the right tower of the suspension bridge are equal to each other, that is α₂=0, and the conditions of α₁>0, α₃<0, h_{P1}≈h₁, h_{P2}≈|h₃|, θ_{C}·δT_{C}≈θ_{P}·δT_{P} are satisfied, the sag variation δf₂ of the main span cable can be estimated by the following equation:

$$δ {f}_{2} = \frac{{r}_{2}}{{\sum }_{j = 1}^{3} {r}_{j}} \cdot \frac{3 {θ}_{C} \cdot δ {T}_{C}}{16 {n}_{2}} {\sum }_{i = 1}^{3} {l}_{i} ;$$

When the sags of the left side span cable and the right side span cable are further ignored, the above equation is simplified as:

$$δ {f}_{2} = \frac{3 {θ}_{C} \cdot δ {T}_{C}}{16 {n}_{2}} {\sum }_{i = 1}^{3} {l}_{i} .$$

When the tower-top elevations of the left tower and the right tower of the suspension bridge are equal to each other, that is α₂=0, the sags of the left side span cable and the right side span cable are neglected, that is, r₁=r₃=0, and the conditions of α₁>0, α₃<0, h_{P1}≈h₁, h_{P2}≈|h₃|, θ_{C}·δT_{C}≈θ_{P}·δT_{P} are satisfied, the tower-top horizontal displacement δlᵢ (i.e. span variation) of the left tower, the tower-top horizontal displacement δl₃ (i.e. span variation) of the right tower, and the tower-top horizontal distance variation δl₂ (the span variation of the main span main cable) are calculated by the following equations:

δl₁=l₁θ_{C}·δT_{C}

δl₂=−(l₁+l₃)θ_{C}·δT_{C}

δl₃=l₃θ_{C}·δT_{C}.

When the suspension bridge is a two-tower self-anchored suspension bridge, the main cable of the two-tower self-anchored suspension bridge is directly anchored to the end of the main girder, and the thermal expansion and contraction of the main girder causes the distance change between both ends of the main cable. Thus, the calculation procedure of the temperature deformation of the two-tower self-anchored suspension bridge is the same as the calculation procedure for the two-tower ground-anchored suspension bridge, provided that the column vector on the right side of the linear system of equations changes from [0 0 0 Δ₁ Δ₂ Δ₃]^{T} to [0 0 Δ_{G} Δ₁ Δ₂ Δ₃]^{T}, while the coefficient matrix remains unchanged. Δ_{G} is a variation of the sum of spans of the left side span cable, the main span cable, and the right side span cable. If the main girder is continuous at the girder-tower intersections with the total length of L_{G}, Δ_{G} can be estimated by Δ_{G}=L_{G}θ_{G}·δT_{G} where θ_{G} is a linear expansion coefficient of the main girder and δT_{G} is a temperature variation of the main girder. Therefore, the temperature deformation of the two-tower self-anchored suspension bridge will be the solution of the following linear system of equations:

$$[ \begin{matrix}- \frac{1}{{f}_{1}} & \frac{1}{{f}_{2}} & 0 & \frac{1}{{l}_{1}} & - \frac{1}{{l}_{2}} & 0 \\ 0 & - \frac{1}{{f}_{2}} & \frac{1}{{f}_{3}} & 0 & \frac{1}{{l}_{2}} & - \frac{1}{{l}_{3}} \\ 0 & 0 & 0 & 1 & 1 & 1 \\ \frac{{c}_{n 1}}{{l}_{1}} & 0 & 0 & {M}_{1} & 0 & 0 \\ 0 & \frac{{c}_{n 2}}{{l}_{2}} & 0 & 0 & {M}_{2} & 0 \\ 0 & 0 & \frac{{c}_{n 3}}{{l}_{3}} & 0 & 0 & {M}_{3}\end{matrix} ] \cdot [ \begin{matrix}δ {f}_{1} \\ δ {f}_{2} \\ δ {f}_{3} \\ δ {l}_{1} \\ δ {l}_{2} \\ δ {l}_{3}\end{matrix} ] = [ \begin{matrix}0 \\ 0 \\ {Δ}_{G} \\ {Δ}_{1} \\ {Δ}_{2} \\ {Δ}_{3}\end{matrix} ] .$$

When the higher-order terms of the sag-to-span ratio nᵢ in the coefficients cₙᵢ, cₗᵢ, and c_{αi} are ignored, the analytical solutions of the sag variation δfᵢ and the span variation δlᵢ of the two-tower self-anchored suspension bridge are respectively:

$$δ {f}_{i} = \frac{{n}_{i}}{cos {α}_{i}} δ {S}_{i} - {n}_{i} tan {α}_{i} ( δ {h}_{Pi} - δ {h}_{P ( i - 1 )} ) + \frac{{n}_{i} ( 3 {l}_{i} - 16 {r}_{i} )}{16 \cdot {\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} - tan {α}_{k} ) \cdot δ {h}_{Pk} - {Δ}_{G} ]$$

$$δ {l}_{i} = \frac{δ {S}_{i}}{cos {α}_{i}} - tan {α}_{i} ( δ {h}_{Pi} - δ {h}_{P ( i - 1 )} ) - \frac{{r}_{i}}{{\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} - tan {α}_{k} ) \cdot δ {h}_{Pk} - {Δ}_{G} ]$$

For the two-tower suspension bridge, a mid-span elevation variation δD₂ of the main span cable can be estimated from the sag variation. The mid-span elevation variation d₂ of the chord of the main span cable caused by the tower height variation is as follows:

$${d}_{2} = \frac{δ {h}_{P 1} + δ {h}_{P 2}}{2} = \frac{{h}_{P 1} + {h}_{P 2}}{2} \cdot {θ}_{P} \cdot δ {T}_{P} .$$

Since the elevation takes the vertical upward direction as positive, the elevation variation δD₂ is equal to minus δf₂ plus d₂, i.e.,

$$δ {D}_{2} = - δ {f}_{2} + \frac{{h}_{P 1} + {h}_{P 2}}{2} \cdot {θ}_{P} \cdot δ {T}_{P} .$$

As the length of the suspender at mid span or the thickness of the central clamp of the suspension bridge are relatively small, and their thermal deformation can be ignored, the elevation variation of the main span girder at mid span can also be approximated by δD₂.

The above analysis method for the temperature deformation of the two-tower suspension bridge can be extended to other cable systems with any number of spans (multi-span suspension bridges, transmission lines, ropeways, etc.). When the cable system has ti spans numbered as 1, 2, . . . , u−1, u and contains u+1 supports (including both ends) numbered as 0, 1, . . . , u−1, u, and u≥1, the calculation method for the temperature-induced sag variation of the main cable and the tower-top horizontal displacement of the multi-span suspension bridge is as follows:

(1) according to the equilibrium condition that the horizontal tensions of the main cables on both sides of the tower top are always equal, establishing the following u−1 equations:

$$\frac{δ {f}_{i}}{{f}_{i}} - \frac{δ {l}_{i}}{{l}_{i}} = \frac{δ {f}_{i + 1}}{{f}_{i + 1}} - \frac{δ {l}_{i + 1}}{{l}_{i + 1}}$$

where i=1, 2, . . . , u−1; fᵢ is the sag (or mid-span deflection) of the i^{th} span main cable; δfᵢ is the variation of fᵢ caused by the temperature variation; lᵢ is the span (horizontal distance of supports at both ends) of the i^{th} span main cable; δlᵢ is the variation of lᵢ caused by the temperature variation;

(2) according to the geometric relationship between the shape of the main cable and the length of the main cable, establishing the following u equations:

$$\frac{{c}_{ni}}{{l}_{i}} \cdot δ {f}_{i} - \frac{{c}_{ni} \cdot {n}_{i}}{{l}_{i}} \cdot δ {l}_{i} + {c}_{li} \cdot δ {l}_{i} - \frac{{c}_{α i} \cdot sin 2 {α}_{i}}{2 \cdot {l}_{i}} \cdot δ {l}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} )$$

where i=1, 2, . . . , u; nᵢ is the sag-to-span ratio of the i^{th} span main cable, i.e. nᵢ=fᵢ/lᵢ; αᵢ is the chord inclination (positive for the counterclockwise rotation from the horizontal line) of the i^{th} span main cable; the coefficients cₙᵢ, cₗᵢ, and c_{αi} are respectively:

$${c}_{ni} = {l}_{i} \cdot [ \frac{16}{3} {n}_{i} {cos}^{3} {α}_{i} - \frac{128}{5} {n}_{i}^{3} ( 5 {cos}^{7} {α}_{i} - 4 {cos}^{5} {α}_{i} ) ]$$

$${c}_{l i} = sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} )$$

$${c}_{α i} = {l}_{i} \cdot [ \frac{sin {α}_{i}}{{cos}^{2} {α}_{i}} - 8 {n}_{i}^{2} sin {α}_{i} {cos}^{2} {α}_{i} + 32 {n}_{i}^{4} {cos}^{4} {α}_{i} sin {α}_{i} ( 7 {cos}^{2} {α}_{i} - 4 ) ]$$

δSᵢ is the length variation of the i^{th} span main cable caused by the temperature variation; δh_{Pi} is the elevation variation of the intermediate supports (tower tops), i=1, 2, . . . , u=1, and δh_{P0}=δh_{P3}=0; and δSᵢ and δh_{Pi} are calculated according to the following equations:

$$δ {S}_{i} = {S}_{i} \cdot {θ}_{C} \cdot δ {T}_{C} = {l}_{i} \cdot {θ}_{C} \cdot δ {T}_{C} [ sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ]$$

$$δ {h}_{P i} = {h}_{Pi} \cdot {θ}_{P} \cdot δ {T}_{P}$$

where θ_{C} is the linear expansion coefficient of the main cable, θ_{P} is the linear expansion coefficient of the tower of the suspension bridge, δT_{C} is the temperature variation of the main cable, δT_{P} is the temperature variation of the bridge tower, and h_{Pi} is the height of the bridge tower;

(3) according to the compatibility condition to be satisfied by the sum of all spans of the main cable, that is, the distance between the anchorages at both ends is constant, establishing the following equation:

$${\sum }_{i = 1}^{u} δ {l}_{i} = 0 ;$$

(4) according to the following linear system of equations consisting of the above equations in steps (1), (2), and (3), simultaneously obtaining the sag variation δfᵢ and the span variation of each span main cable:

$$[ \begin{matrix}{A}_{( u - 1 ) \times u} & {B}_{( u - 1 ) \times u} \\ {0}_{1 \times u} & {1}_{1 \times u} \\ {C}_{u \times u} & {D}_{u \times u}\end{matrix} ] \cdot [ \begin{matrix}δ {F}_{u \times 1} \\ δ {L}_{u \times 1}\end{matrix} ] = [ \begin{matrix}{0}_{u \times 1} \\ {Δ}_{u \times 1}\end{matrix} ]$$

where A, B, C, D, 0, 1, δF, δL, Δ represent a matrix or a vector, and the subscript represents the size of the matrix or vector. The elements in matrix A, B, C, D are as follows:

$${A}_{ij} = \{ \begin{matrix}- 1 / {f}_{i} & when i = j \\ 1 / {f}_{j} & when i + 1 = j \\ 0 & others\end{matrix} , \\ i = 1 , 2 , … , u - 1 ; j = 1 , 2 , … , u ; \\ {B}_{ij} = \{ \begin{matrix}1 / {l}_{i} & when i = j \\ - 1 / {l}_{j} & when i + 1 = j \\ 0 & others\end{matrix} , \\ i = 1 , 2 , … , u - 1 ; j = 1 , 2 , … , u ; \\ {C}_{ij} = \{ \begin{matrix}{c}_{ni} / {l}_{i} & when i = j \\ 0 & others\end{matrix} , \\ i = 1 , 2 , … , u ; j = 1 , 2 , … , u ; \\ {D}_{ij} = \{ \begin{matrix}{M}_{i} & when i = j \\ 0 & others\end{matrix} , \\ i = 1 , 2 , … , u ; j = 1 , 2 , … , u ; where \\ {M}_{i} = - \frac{{c}_{ni} \cdot {n}_{i}}{{l}_{i}} + {c}_{li} - \frac{{c}_{α i} \cdot sin 2 {α}_{i}}{2 \cdot {l}_{i}} ;$$

0 or 1 represent a vector with all elements being 0 or 1. For example, 0_{1×u} is a 1-by-u vector of zeros, and 1_{1×u} is a 1-by-u vector of ones. The remaining vectors are:

$$δ {F}_{u \times 1} = {[ δ {f}_{1} δ {f}_{2} … δ {f}_{u} ]}^{T}$$

$$δ {L}_{u \times 1} = {[ δ {l}_{1} δ {l}_{2} … δ {l}_{u} ]}^{T}$$

$${Δ}_{u \times 1} = {[ {Δ}_{1} {Δ}_{2} … {Δ}_{u} ]}^{T} where$$

$${Δ}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} ) .$$

The advantages of the above-mentioned technical solution of the present disclosure are as follows.

The above solution provides a general method for determining the temperature-induced sag variation of the main cable and the tower-top horizontal displacement of the two-tower ground-anchored suspension bridge or the two-tower self-anchored suspension bridge and other cable systems with any number of spans (multi-span suspension bridges, transmission lines, ropeways, etc.). The method facilitates the temperature deformation calculation as it merely relies on the overall geometry of a suspension bridge rather than the finite element model or the regression model based on long-term measured data. Also, the derived formulas have merits of clear concepts, general applicability, and great convenience for parametric analysis and field calculation. The present disclosure can be used to guide the deployment of measurement points in the structural health monitoring system of suspension bridges, and to provide a priori knowledge for establishing a temperature-deformation baseline model.

The general calculation method for the sag variation of the main cable and the tower-top horizontal displacement of suspension bridges under the ambient temperature variation, according to the present disclosure, belongs to the physics-based formula method. The method takes the variation in the span and sag of each span cable of a suspension bridge as the unknown quantities, and constructs a linear system of equations to solve them by using the following three conditions: 1) the equilibrium condition that the horizontal tensions of the main cables on both sides of the tower top are always equal, 2) the geometric relationship between the shape and the length of the main cable, and 3) the compatibility condition to be satisfied by the sum of all spans of the main cable. For a three-span suspension bridge, the present disclosure not only gives accurate formulas of the solution to the above-mentioned linear system of equations, but also gives approximate calculation formulas which are convenient for field applications. As the main cable and the tower contributions as well as the sag effect of the side span cables are taken into consideration, the present disclosure provides a good estimation of the temperature deformation of suspension bridges with high accuracy.

### BRIEF DESCRIPTION OF THE DRAWINGS

FIG. 1 is a simplified analysis model of a two-tower ground-anchored suspension bridge according to an embodiment of the present disclosure.

FIG. 2 is a schematic diagram showing the deformation of a two-tower ground-anchored suspension bridge according to an embodiment of the present disclosure.

FIG. 3 is a simplified analysis model of a multi-span cable system according to an embodiment of the present disclosure.

### DETAILED DESCRIPTION OF THE EMBODIMENTS

In order to illustrate the technical problems, the technical solutions, and the advantages of the present disclosure, the present disclosure is described below in detail with reference to the drawings and the specific embodiments.

The present disclosure provides a method for determining the variations in the main cable sag and tower-top horizontal displacement of suspension bridges with the ambient temperature changes.

The method includes the following steps.

(1) According to the equilibrium condition that the horizontal tensions of the main cable on both sides of the tower top are always equal, the following equation is established:

$$\frac{δ {f}_{i}}{{f}_{i}} - \frac{δ {l}_{i}}{{l}_{i}} = \frac{δ {f}_{i + 1}}{{f}_{i + 1}} - \frac{δ {l}_{i + 1}}{{l}_{i + 1}}$$

where, i=1, 2; fᵢ is the sag of the i^{th} span main cable; δfᵢ is the variation of fᵢ caused by temperature variations; lᵢ is the span of the i^{th} span main cable; δlᵢ is the variation of lᵢ caused by temperature variations; the subscripts 1, 2, 3 of the variables indicate the left side span, the main span, and the right side span, respectively.

(2) According to the geometric relationship between the shape of the main cable and the length of the main cable, the following equation is established:

$$\frac{{c}_{ni}}{{l}_{i}} \cdot δ {f}_{i} - \frac{{c}_{ni} \cdot {n}_{i}}{{l}_{i}} \cdot δ {l}_{i} + {c}_{li} \cdot δ {l}_{i} - \frac{{c}_{α i} \cdot sin 2 {α}_{i}}{2 \cdot {l}_{i}} \cdot δ {l}_{i} = δ {S}_{i} - \frac{{c}_{α i} \cdot {cos}^{2} {α}_{i}}{2 \cdot {l}_{i}} \cdot ( δ {h}_{P i} - δ {h}_{P ( i - 1 )} )$$

where: i=1, 2, 3; nᵢ is the sag-to-span ratio of the i^{th} span main cable, i.e. nᵢ=fᵢ/lᵢ; αᵢ is the chord inclination of the i^{th} span main cable; the coefficients cₙᵢ, cₗᵢ, and c_{αi} are respectively:

$${c}_{ni} = {l}_{i} \cdot [ \frac{16}{3} {n}_{i} {cos}^{3} {α}_{i} - \frac{128}{5} {n}_{i}^{3} ( 5 {cos}^{7} {α}_{i} - 4 {cos}^{5} {α}_{i} ) ]$$

$${c}_{li} = sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} )$$

$${c}_{α i} = {l}_{i} \cdot [ \frac{sin {α}_{i}}{{cos}^{2} {α}_{i}} - 8 {n}_{i}^{2} sin {α}_{i} {cos}^{2} {α}_{i} + 32 {n}_{i}^{4} {cos}^{4} {α}_{i} sin {α}_{i} ( 7 {cos}^{2} {α}_{i} - 4 ) ]$$

δSᵢ is the length variation of the i^{th} span main cable caused by temperature variations.

δh_{Pi} and δh_{P(i-1)} are the elevation change of the supports i and i−1 of the main cable, respectively, and since the position of the anchorages are unchanged, δh_{P0}=δh_{P3}=0.

δSᵢ (i=1, 2, 3) and δh_{Pi} (i=1, 2) are estimated by the following equations:

$$δ {S}_{i} = {S}_{i} \cdot {θ}_{C} \cdot δ {T}_{C} = {l}_{i} \cdot {θ}_{C} \cdot δ {T}_{C} [ sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ]$$

δh_{Pi}=h_{Pi}·θ_{P}·δT_{P}

where θ_{C} and θ_{P} are respectively the linear expansion coefficients of the main cable and the tower, δT_{C} and δT_{P} are respectively the temperature variation of the main cable and the tower, and h_{Pi} is the height of the tower.

(3) According to the compatibility condition to be satisfied by the sum of spans of the left side span cable, the main span cable, and the right side span cable, that is, the distance between the anchorages at both ends is constant, the following equation is established:

$${\sum }_{i = 1}^{3} δ {l}_{i} = 0 ;$$

(4) According to the following linear system of equations consisting of the equations in steps (1), (2), and (3), the sag variation δfᵢ and the span variation δlᵢ of each span of the main cable can be simultaneously obtained:

$$[ \begin{matrix}- \frac{1}{{f}_{1}} & \frac{1}{{f}_{2}} & 0 & \frac{1}{{l}_{1}} & - \frac{1}{{l}_{2}} & 0 \\ 0 & - \frac{1}{{f}_{2}} & \frac{1}{{f}_{3}} & 0 & \frac{1}{{l}_{2}} & \frac{1}{{l}_{3}} \\ 0 & 0 & 0 & 1 & 1 & 1 \\ \frac{{c}_{n 1}}{{l}_{1}} & 0 & 0 & {M}_{1} & 0 & 0 \\ 0 & \frac{{c}_{n 2}}{{l}_{2}} & 0 & 0 & {M}_{2} & 0 \\ 0 & 0 & \frac{{c}_{n 3}}{{l}_{3}} & 0 & 0 & {M}_{3}\end{matrix} ] \cdot [ \begin{matrix}δ {f}_{1} \\ δ {f}_{2} \\ δ {f}_{3} \\ δ {l}_{1} \\ δ {l}_{2} \\ δ {l}_{3}\end{matrix} ] = [ \begin{matrix}0 \\ 0 \\ 0 \\ {Δ}_{1} \\ {Δ}_{2} \\ {Δ}_{3}\end{matrix} ] where \text{:}$$

$${M}_{i} = - \frac{{c}_{ni} \cdot {n}_{i}}{{l}_{i}} + {c}_{li} - \frac{{c}_{α i} \cdot sin 2 {α}_{i}}{2 \cdot {l}_{i}} , \\ {Δ}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} ) , i = 1 , 2 , 3.$$

The above-mentioned calculation method is further described below with reference to the specific embodiments.

The equation based on the horizontal tension equilibrium on the tower top in step (1) is specifically derived as follows.

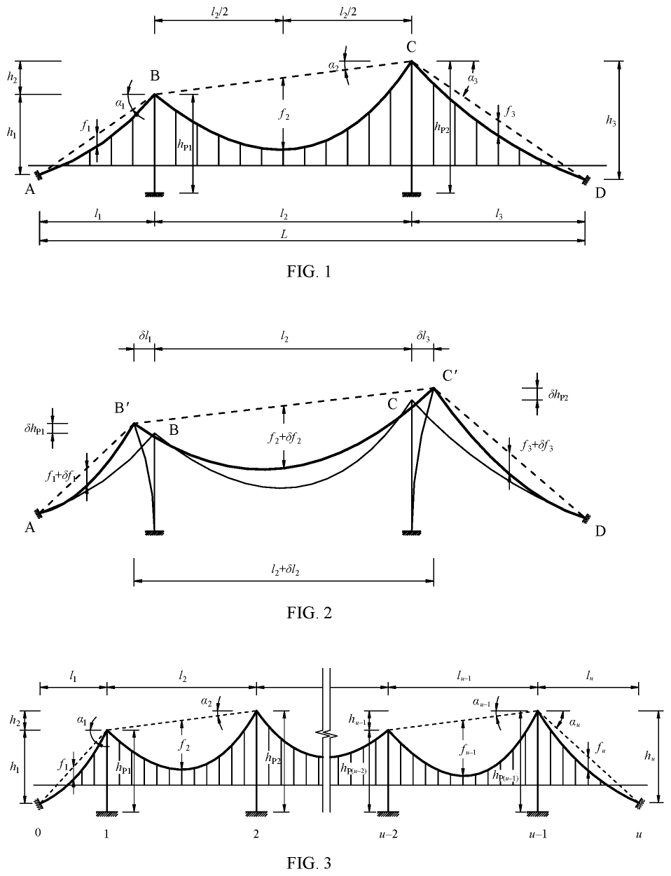

In the analysis model of a two-tower suspension bridge shown in FIG. 1, lᵢ, fᵢ, αᵢ and hᵢ represent the span, the sag, the chord inclination (positive for the counterclockwise rotation from the horizontal line), and the elevation difference of the supports of each span of the main cable, respectively. The subscripts 1, 2, 3 indicate the left side span, the main span, and the right side span, respectively. The heights (the length subjected to the temperature changes) of the left and right towers are respectively defined as h_{P1} and h_{P2}. The horizontal distance between the anchorages at both ends of the main cable is L. The variations in the span and the sag of each span cable are respectively δlᵢ and δfᵢ (i=1, 2, 3) as shown in FIG. 2.

When the i^{th} span main cable is subjected to the vertical load qᵢ uniformly distributed along the span lᵢ, the cable curve is a parabola, and the horizontal components Hᵢ of the tension in the cable is a constant. The total vertical load acting on the i^{th} span main cable is Wᵢ=qᵢ·lᵢ, and the cable sag is

$${f}_{i} = \frac{{W}_{i} \cdot {l}_{i}}{8 {H}_{i}} \qquad ( 1 )$$

As δWᵢ=0, the differentiation of the above equation leads to:

$$\frac{δ {f}_{i}}{{f}_{i}} = \frac{δ {l}_{i}}{{l}_{i}} - \frac{δ {H}_{i}}{{H}_{i}} \qquad ( 2 )$$

The horizontal tension equilibrium on the tower top is assumed to be maintained, so

$$\frac{δ {H}_{1}}{{H}_{1}} = \frac{δ {H}_{2}}{{H}_{2}} = \frac{δ {H}_{3}}{{H}_{3}} \qquad ( 3 )$$

By combining the equations (2) and (3), the following two equations can be obtained (i=1, 2):

$$\frac{δ {f}_{i}}{{f}_{i}} - \frac{δ {l}_{i}}{{l}_{i}} = \frac{δ {l}_{i + 1}}{{f}_{i + 1}} - \frac{δ {l}_{i + 1}}{{l}_{i + 1}} \qquad ( 4 )$$

The equation based on the geometric relationship between the shape and the length of the main cable in step (2) is specifically derived as follows.

The formula for calculating the length of each span main cable is:

$${S}_{i} = {l}_{i} [ sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ] \qquad ( 5 )$$

where nᵢ is the sag-to-span ratio, that is:

$${n}_{i} = \frac{{f}_{i}}{{l}_{i}} \qquad ( 6 )$$

Differentiating the equation (5) yields:

δSᵢ=cₙᵢ·δnᵢ+cₗᵢ·δₗᵢ+c_{αi}·δαᵢ (7)

where the coefficients cₙᵢ, cₗᵢ, and c_{αi} are respectively:

$$\begin{matrix}{c}_{ni} = {l}_{i} \cdot [ \frac{16}{3} {n}_{i} {cos}^{3} {α}_{i} - \frac{128}{5} {n}_{i}^{3} ( 5 {cos}^{7} {α}_{i} - 4 {cos}^{5} {α}_{i} ) ] & ( 8 ) \\ {c}_{li} = sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) & ( 9 ) \\ {c}_{α i} = {l}_{i} \cdot [ \frac{sin {α}_{i}}{{cos}^{2} {α}_{i}} - 8 {n}_{i}^{2} {α}_{i} {cos}^{2} {α}_{i} + 32 {n}_{i}^{4} {cos}^{4} {α}_{i} sin {α}_{i} ( 7 {cos}^{2} {α}_{i} - 4 ) ] & ( 10 )\end{matrix}$$

δnᵢ and δ_{αi} in the equation (7) can be replaced by the expressions containing δlᵢ and δfᵢ. Differentiating the equation (6) with respect to fᵢ and 1ᵢ leads to:

$$δ {n}_{i} = δ ( \frac{{f}_{i}}{{l}_{i}} ) = \frac{{l}_{i} \cdot δ {f}_{i} - {f}_{i} \cdot δ {l}_{i}}{{l}_{i}^{2}} \qquad ( 11 )$$

The elevation difference between the two end supports of each span cable is:

hᵢ=lᵢ·tan αᵢ (12)

By differentiating the equation (12) with respect to lᵢ and αᵢ, the following equation is obtained:

δhᵢ=δlᵢ·tan αᵢ+lᵢ·sec²αᵢ·δαᵢ (13)

δhᵢ is equal to the difference of the elevation changes at two end supports of each span cable:

δhᵢ=δh_{Pi}−δh_{P(i-1)} (14)

where i=1, 2, 3, δh_{P0} and δh_{P3} correspond to the elevation variation of the left and right anchorages, respectively, so δh_{P0}=δh_{P3}=0. Substituting the equation (14) into the equation (13), δαᵢ is obtained:

$${δα}_{i} = - \frac{sin 2 {α}_{i}}{2 \cdot {l}_{i}} \cdot δ {l}_{i} + \frac{{cos}^{2} {α}_{i}}{{l}_{i}} ( δ {h}_{Pi} - δ {h}_{P ( i - 1 )} ) \qquad ( 15 )$$

By substituting the equations (11) and (15) into the equation (7), three equations can be obtained as follows (i=1, 2, 3):

$$\frac{{c}_{ni}}{{l}_{i}} \cdot δ {f}_{i} - \frac{{c}_{ni} \cdot {n}_{i}}{{l}_{i}} \cdot δ {l}_{i} + {c}_{li} \cdot δ {l}_{i} - \frac{{c}_{α i} \cdot sin 2 {α}_{i}}{2 \cdot {l}_{i}} \cdot δ {l}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} ) \qquad ( 16 )$$

where δSᵢ (i=1, 2, 3) is the length variation of the i^{th} span main cable caused by temperature variations, and δh_{Pi} (1=1, 2) is the height variation of the towers. δSᵢ and δh_{Pi} can be estimated by the linear expansion coefficient as follows:

$$\begin{matrix}δ {S}_{i} = {S}_{i} \cdot {θ}_{C} \cdot δ {T}_{C} = {l}_{i} \cdot {θ}_{C} \cdot δ {T}_{C} [ sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ] & ( 17 ) \\ δ {h}_{Pi} = {h}_{Pi} \cdot {θ}_{P} \cdot δ {T}_{P} & ( 18 )\end{matrix}$$

where θ_{C} and θ_{P} are the linear expansion coefficients of the main cable and the tower, respectively; δT_{C} and δT_{P} are the temperature variations of the main cable and the tower, respectively; and h_{Pi} is the height of the tower.

In step (3), according to the compatibility condition to be satisfied by the sum of spans of the left side span, main span, and right side span main cables, that is, the distance between the anchorages at both ends is constant, the following equation is established:

$${\sum }_{i = 1}^{3} δ {l}_{i} = 0 \qquad ( 19 )$$

In step (4), the above equations (4), (16), and (19) constitute a linear system of equations with six unknowns δf₁, δf₂, δf₃, δl₁, δl₂ and δl₃.

$$\begin{matrix}[ \begin{matrix}- \frac{1}{{f}_{1}} & \frac{1}{{f}_{2}} & 0 & \frac{1}{{l}_{1}} & - \frac{1}{{l}_{2}} & 0 \\ 0 & - \frac{1}{{f}_{2}} & \frac{1}{{f}_{3}} & 0 & \frac{1}{{l}_{2}} & \frac{1}{{l}_{3}} \\ 0 & 0 & 0 & 1 & 1 & 1 \\ \frac{{c}_{n 1}}{{l}_{1}} & 0 & 0 & {M}_{1} & 0 & 0 \\ 0 & \frac{{c}_{n 2}}{{l}_{2}} & 0 & 0 & {M}_{2} & 0 \\ 0 & 0 & \frac{{c}_{n 3}}{{l}_{3}} & 0 & 0 & {M}_{3}\end{matrix} ] \cdot [ \begin{matrix}δ {f}_{1} \\ δ {f}_{2} \\ δ {f}_{3} \\ δ {l}_{1} \\ δ {l}_{2} \\ δ {l}_{3}\end{matrix} ] = [ \begin{matrix}0 \\ 0 \\ 0 \\ {Δ}_{1} \\ {Δ}_{2} \\ {Δ}_{3}\end{matrix} ] where & ( 20 ) \\ {M}_{i} = - \frac{{c}_{ni} \cdot {n}_{i}}{{l}_{i}} + {c}_{li} - \frac{{c}_{α i} \cdot sin 2 {α}_{i}}{2 \cdot {l}_{i}} & ( 21 ) \\ {Δ}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} ) & ( 22 )\end{matrix}$$

By solving the equation (20), the sag variation δfᵢ (i=1, 2, 3) and the span variation δlᵢ (i=1, 2, 3) of each span main cable can be obtained.

The tower-top horizontal displacement of the left and right towers are δl₁ and δl₃, respectively (positive for the movement toward the main span), and the horizontal distance variation between both tower tops is δl₂.

The sag-to-span ratio of the main span cable of a suspension bridge is generally between 1/12 and 1/9, while the sag-to-span ratios of the side span cables are even smaller than that of the main span cable. Therefore, the higher-order terms of nᵢ in the equations (8) to (10) can be ignored, that is,

$$\begin{matrix}{c}_{ni} = \frac{16}{3} {l}_{i} \cdot {n}_{i} {cos}^{3} {α}_{i} & ( 23 ) \\ {c}_{li} = sec {α}_{i} & ( 24 ) \\ {c}_{α i} = {l}_{i} \cdot \frac{sin {α}_{i}}{{cos}^{2} {α}_{i}} & ( 25 )\end{matrix}$$

By substituting the equations (23) to (25) into the equation (20) and replacing the sag fᵢ with nᵢ·lᵢ, the solution of the equation (20) can be written as follows:

$$\begin{matrix}δ {f}_{1} = [ \frac{{n}_{1} ( 3 {l}_{1} - 16 {r}_{1} )}{16 cos {α}_{1} \cdot {\sum }_{i = 1}^{3} {r}_{i}} + \frac{{n}_{1}}{cos {α}_{1}} ] δ {S}_{1} + \frac{{n}_{1} ( 3 {l}_{1} - 16 {r}_{1} )}{16 cos {α}_{2} \cdot {\sum }_{i = 1}^{3} {r}_{i}} δ {S}_{2} + \frac{{n}_{1} ( 3 {l}_{1} - 16 {r}_{1} )}{16 cos {α}_{3} \cdot {\sum }_{i = 1}^{3} {r}_{i}} δ {S}_{3} + [ \frac{{n}_{1} ( 3 {l}_{1} - 16 {r}_{1} ) ( tan {α}_{2} - tan {α}_{1} )}{16 \cdot {\sum }_{i = 1}^{3} {r}_{i}} - {n}_{1} \cdot tan {α}_{1} ] δ {h}_{P 1} - \frac{{n}_{1} ( 3 {l}_{1} - 16 {r}_{1} ) ( tan {α}_{2} - tan {α}_{3} )}{16 \cdot {\sum }_{i = 1}^{3} {r}_{i}} δ {h}_{P 2} & ( 26 ) \\ δ {f}_{2} = \frac{{n}_{2} ( 3 {l}_{2} - 16 {r}_{2} )}{16 cos {α}_{1} \cdot {\sum }_{i = 1}^{3} {r}_{i}} δ {S}_{1} + [ \frac{{n}_{2}}{cos {α}_{2}} + \frac{{n}_{2} ( 3 {l}_{2} - 16 {r}_{2} )}{16 cos {α}_{2} \cdot {\sum }_{i = 1}^{3} {r}_{i}} ] δ {S}_{2} + \frac{{n}_{2} ( 3 {l}_{2} - 16 {r}_{2} )}{16 cos {α}_{3} \cdot {\sum }_{i = 1}^{3} {r}_{i}} δ {S}_{3} + [ \frac{{n}_{2} ( 3 {l}_{2} - 16 {r}_{2} ) ( tan {α}_{2} - tan {α}_{1} )}{16 \cdot {\sum }_{i = 1}^{3} {r}_{i}} + {n}_{2} \cdot tan {α}_{2} ] δ {h}_{P 1} - [ \frac{{n}_{2} ( 3 {l}_{2} - 16 {r}_{2} ) ( tan {α}_{2} - tan {α}_{3} )}{16 \cdot {\sum }_{i = 1}^{3} {r}_{i}} + {n}_{2} \cdot tan {α}_{2} ] δ {h}_{P 2} & ( 27 ) \\ δ {f}_{3} = \frac{{n}_{3} ( 3 {l}_{3} - 16 {r}_{3} )}{16 cos {α}_{1} \cdot {\sum }_{i = 1}^{3} {r}_{i}} δ {S}_{1} + \frac{{n}_{3} ( 3 {l}_{3} - 16 {r}_{3} )}{16 cos {α}_{2} \cdot {\sum }_{i = 1}^{3} {r}_{i}} δ {S}_{2} + [ \frac{{n}_{3} ( 3 {l}_{3} - 16 {r}_{3} )}{16 cos {α}_{3} \cdot {\sum }_{i = 1}^{3} {r}_{i}} \frac{{n}_{3}}{cos {α}_{3}} ] δ {S}_{3} + \frac{{n}_{3} ( 3 {l}_{3} - 16 {r}_{3} ) ( tan {α}_{2} - tan {α}_{1} )}{16 \cdot {\sum }_{i = 1}^{3} {r}_{i}} δ {h}_{P 1} - [ \frac{{n}_{3} ( 3 {l}_{3} - 16 {r}_{3} ) ( tan {α}_{2} - tan {α}_{3} )}{16 \cdot {\sum }_{i = 1}^{3} {r}_{i}} - {n}_{3} \cdot tan {α}_{3} ] δ {h}_{P 2} & ( 28 ) \\ δ {l}_{1} = [ \frac{1}{cos {α}_{1}} - \frac{{r}_{1}}{cos {α}_{1} \cdot {\sum }_{i = 1}^{3} {r}_{i}} ] δ {S}_{1} - \frac{{r}_{1}}{cos {α}_{2} \cdot {\sum }_{i = 1}^{3} {r}_{i}} δ {S}_{2} - \frac{{r}_{1}}{cos {α}_{3} \cdot {\sum }_{i = 1}^{3} {r}_{i}} δ {S}_{3} + [ \frac{{r}_{1} ( tan {α}_{2} - tan {α}_{1} )}{{\sum }_{i = 1}^{3} {r}_{i}} - tan {α}_{1} ] δ {h}_{P 1} - \frac{{r}_{1} ( tan {α}_{3} - tan {α}_{2} )}{{\sum }_{i = 1}^{3} {r}_{i}} δ {h}_{P 2} & ( 29 ) \\ δ {l}_{2} = \frac{{r}_{2}}{cos {α}_{1} \cdot {\sum }_{i = 1}^{3} {r}_{i}} δ {S}_{1} + [ \frac{1}{cos {α}_{2}} - \frac{{r}_{2}}{cos {α}_{2} \cdot {\sum }_{i = 1}^{3} {r}_{i}} ] δ {S}_{2} - \frac{{r}_{2}}{cos {α}_{3} \cdot {\sum }_{i = 1}^{3} {r}_{i}} δ {S}_{3} + [ \frac{{r}_{2} ( tan {α}_{1} - tan {α}_{3} )}{{\sum }_{i = 1}^{3} {r}_{i}} + tan {α}_{2} ] δ {h}_{P 1} - [ \frac{{r}_{2} ( tan {α}_{3} - tan {α}_{2} )}{{\sum }_{i = 1}^{3} {r}_{i}} + tan {α}_{2} ] δ {h}_{P 2} & ( 30 ) \\ δ {l}_{3} = - \frac{{r}_{1}}{cos {α}_{1} \cdot {\sum }_{i = 1}^{3} {r}_{i}} δ {S}_{1} - \frac{{r}_{3}}{cos {α}_{2} \cdot {\sum }_{i = 1}^{3} {r}_{i}} δ {S}_{2} + [ \frac{1}{cos {α}_{3}} - \frac{{r}_{3}}{cos {α}_{3} \cdot {\sum }_{i = 1}^{3} {r}_{i}} ] δ {S}_{3} + \frac{{r}_{3} ( tan {α}_{1} - tan {α}_{3} )}{{\sum }_{i = 1}^{3} {r}_{i}} δ {h}_{P 1} - [ \frac{{r}_{3} ( tan {α}_{3} - tan {α}_{2} )}{{\sum }_{i = 1}^{3} {r}_{i}} - tan {α}_{3} ] δ {h}_{P 2} & ( 31 )\end{matrix}$$

where the parameter rᵢ (i=1, 2, 3) is as follows:

rᵢ=lᵢ·nᵢ²·cos²αᵢ (32)

The equations (26) to (31) can be written in a compact form as follows (i=1, 2, 3):

$$\begin{matrix}δ {f}_{i} = \frac{{n}_{i}}{cos {α}_{i}} δ {S}_{i} - {n}_{i} tan {α}_{i} ( δ {h}_{Pi} - δ {h}_{P ( i - 1 )} ) + \frac{{n}_{i} ( 3 {l}_{i} - 16 {r}_{i} )}{16 \cdot {\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} tan {α}_{k} ) \cdot δ {h}_{Pk} ] & ( 33 ) \\ δ {l}_{i} = \frac{δ {S}_{i}}{cos {α}_{i}} - tan {α}_{i} ( δ {h}_{Pi} - δ {h}_{P ( i - 1 )} ) - \frac{{r}_{i}}{{\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} tan {α}_{k} ) \cdot δ {h}_{Pk} ] & ( 34 )\end{matrix}$$

The sag variation δf₂ of the main span cable of a suspension bridge is usually more concerned, and the equation (27) can be rewritten as follows:

$$δ {f}_{2} = \frac{{n}_{2} ( 3 {l}_{2} - 16 {r}_{2} )}{16 cos {α}_{1} \cdot {\sum }_{i = 1}^{3} {r}_{i}} δ {S}_{1} + \frac{{n}_{2} ( 3 {l}_{2} + 16 {r}_{1} + 16 {r}_{2}}{16 cos {α}_{2} \cdot {\sum }_{i = 1}^{3} {r}_{i}} δ {S}_{2} + \frac{{n}_{2} ( 3 {l}_{2} - 16 {r}_{2} )}{16 cos {α}_{3} \cdot {\sum }_{i = 1}^{3} {r}_{i}} δ {S}_{3} + \frac{{n}_{2} [ ( 3 {l}_{2} + 16 {r}_{1} + 16 {r}_{2} ) \cdot tan {α}_{2} - ( 3 {l}_{2} - 16 {r}_{2} ) \cdot tan {α}_{1} ]}{16 \cdot {\sum }_{i = 1}^{3} {r}_{i}} δ {h}_{P 1} - \frac{{n}_{2} [ ( 3 {l}_{2} + 16 {r}_{1} + 16 {r}_{3} ) \cdot tan {α}_{2} - ( 3 {l}_{2} - 16 {r}_{2} ) \cdot tan {α}_{3} ]}{16 \cdot {\sum }_{i = 1}^{3} {r}_{i}} δ {h}_{P 2} \qquad ( 35 )$$

According to the equation (1), the sag-to-span ratio is nᵢ=qᵢ·lᵢ/(8Hᵢ). Assuming that the horizontal tension Hᵢ and the vertical distributed load qᵢ are respectively equal for different spans of the main cable, the sag-to-span ratio of each span cable is proportional to the span. The span ratio of each span cable to the main span cable is defined as ζᵢ (i=1, 2, 3) then

$${ζ}_{i} = \frac{{l}_{i}}{{l}_{2}} = \frac{{n}_{i}}{{n}_{2}} \qquad ( 36 )$$

According to the equation (36), lᵢ=ζᵢ·l₂, and the ratio is calculated as follows:

$$\frac{16 {r}_{i}}{3 {l}_{2}} = \frac{16 \cdot {ζ}_{i} {l}_{2} \cdot {n}_{i}^{2} {cos}^{2} {α}_{i}}{3 {l}_{2}} = \frac{16}{3} {n}_{2}^{2} \cdot {ζ}_{i}^{3} \cdot {cos}^{2} {α}_{i} \leq \frac{16}{3} {n}_{2}^{2} \cdot {ζ}_{i}^{3} \qquad ( 37 )$$

The sag-to-span ratio n₂ of the main span cable is usually between 1/12 and 1/9, and herein, the maximum of 1/9 is taken. Since the side span is usually no more than half of the main span, that is ζᵢ≤0.5, 16rᵢ/(3l₂)≤0.8% for i=1, 3. Due to ζ₂=1, 16r₂/(3l₂)≤6.6%. By introducing 3l₂+16r₁+16r₃≈3l₂ and 3l₂−16r₂≈3l₂, the equation (35) is simplified as follows:

$$δ {f}_{2} = \frac{3 {l}_{2} {n}_{2}}{16 \cdot {\sum }_{i = 1}^{3} {r}_{i}} [ \frac{δ {S}_{1}}{cos {α}_{1}} + \frac{δ {S}_{2}}{cos {α}_{2}} + \frac{δ {S}_{3}}{cos {α}_{3}} + ( tan {α}_{2} - tan {α}_{1} ) δ {h}_{P 1} - ( tan {α}_{2} - tan {α}_{3} ) δ {h}_{P 2} ] \qquad ( 38 )$$

When the sags of the side span cables are ignored, that is r₁=r₃=0, the equation (38) becomes:

$$δ {f}_{2} = \frac{3}{16 {n}_{2} \cdot {cos}^{2} {α}_{2}} [ \frac{δ {S}_{1}}{cos {α}_{1}} + \frac{δ {S}_{2}}{cos {α}_{2}} + \frac{δ {S}_{3}}{cos {α}_{3}} + ( tan {α}_{2} - tan {α}_{1} ) δ {h}_{P 1} - ( tan {α}_{2} - tan {α}_{3} ) δ {h}_{P 2} ] \qquad ( 39 )$$

Most suspension bridges have both tower tops at the same elevation (α₂=0), and α₁>0 and α₃<0. The higher-order terms in equations (17) and (18) can be ignored, that is, δSᵢ=lᵢ sec αᵢ·θ_{C}·δT_{C} (i=1, 2, 3) and δh_{Pj}=h_{Pj}·θ_{P}·δT_{P} (j=1, 2), and the structural geometric dimensions can be used to represent the trigonometric functions, that is, sec αᵢ=\sqrt{lᵢ²+hᵢ²}/lᵢ and tan αᵢ=hᵢ/lᵢ (i=1, 2, 3). Under the approximations that h_{P1}≈h₁, h_{P2}≈|h₃|, θ_{C}·δT_{C}≈θ_{P}·δT_{P}, the equations (38) and (39) can be greatly simplified as follows:

$$\begin{matrix}δ {f}_{2} = \frac{{r}_{2}}{{\sum }_{j = 1}^{3} {r}_{j}} \cdot \frac{3 {θ}_{C} \cdot δ {T}_{C}}{16 {n}_{2}} {\sum }_{i = 1}^{3} {l}_{i} & ( 40 ) \\ δ {f}_{2} = \frac{3 {θ}_{C} \cdot δ {T}_{C}}{16 {n}_{2}} {\sum }_{i = 1}^{3} {l}_{i} & ( 41 )\end{matrix}$$

When the elevations of both tower tops of a suspension bridge are equal (α₂=0), the side span cable sag is not considered (r₁=r₂=0), and the approximations of α₁>0, α₃<0, h_{P1}≈h₁, h_{P2}≈|h₃|, θ_{C}·δT_{C}≈θ_{P}·δT_{P} are adopted, the equations (29) to (31) to calculate the tower-top horizontal displacement δlᵢ (i=1, 2, 3) can be greatly simplified as:

δl₁=l₁θ_{C}·δT_{C} (42)

δl₂=−(l₁+l₃)θ_{C}·δT_{C} (43)

δl₃=l₃θ_{C}·δT_{C} (44)

The field monitoring usually measures the elevation variation of the main span cable or girder by GPS technology. In order to facilitate the comparison with the measurement, it is necessary to give a formula to estimate the elevation variation. The thermal expansion and contraction of the tower will change the mid-span elevation of the chord of the main span cable, which is denoted as d₂:

$${d}_{2} = \frac{δ {h}_{P 1} + δ {h}_{P 2}}{2} = \frac{{h}_{P 1} + {h}_{P 2}}{2} \cdot {θ}_{P} \cdot δ {T}_{P} \qquad ( 45 )$$

Since the elevation takes the vertical upward direction as positive, the elevation variation δD₂ of the main span cable at mid span is equal to minus δf₂ plus d₂:

$$δ {D}_{2} = - δ {f}_{2} + \frac{{h}_{P 1} + {h}_{P 2}}{2} \cdot {θ}_{P} \cdot δ {T}_{P} \qquad ( 46 )$$

As the length of the suspender at mid span or the thickness of the central clamp of the suspension bridge are relatively small, and their thermal deformation can be ignored, the elevation variation of the main span girder at mid span can also be approximated by δD₂.

The main cable of a self-anchored suspension bridge is directly anchored to the end of the main girder, so the thermal expansion and contraction of the main girder cause the distance change between both ends of the main cable. It is assumed that the main girder is continuous at the girder-tower intersections with the total length of L_{G}, and the linear expansion coefficient and the temperature variation of the girder are θ_{G} and δT_{G}, respectively. As a result, the horizontal distance variation between both ends of the main cable is Δ_{G}=L_{G}θ_{G}·δT_{G}, and then the equation (19) becomes:

δl₁+δl₂+δl₃=Δ_{G} (47)

Assuming that the vertical load on each span cable is the same and the horizontal tension equilibrium at the tower top is always maintained, the column vector on the right side of the linear system of equations, i.e., the equation (20), should be changed from [0 0 0 Δ₁ Δ₂ Δ₃]^{T} to [0 0 Δ_{G} Δ₁ Δ₂ Δ₃]^{T}, while the coefficient matrix remains unchanged. Therefore, the temperature deformation of the two-tower self-anchored suspension bridge will be the solution of the following linear system of equations:

$$[ \begin{matrix}- \frac{1}{{f}_{1}} & \frac{1}{{f}_{2}} & 0 & \frac{1}{{l}_{1}} & - \frac{1}{{l}_{2}} & 0 \\ 0 & - \frac{1}{{f}_{2}} & \frac{1}{{f}_{3}} & 0 & \frac{1}{{l}_{2}} & \frac{1}{{l}_{3}} \\ 0 & 0 & 0 & 1 & 1 & 1 \\ \frac{{c}_{n 1}}{{l}_{1}} & 0 & 0 & {M}_{1} & 0 & 0 \\ 0 & \frac{{c}_{n 2}}{{l}_{2}} & 0 & 0 & {M}_{2} & 0 \\ 0 & 0 & \frac{{c}_{n 3}}{{l}_{3}} & 0 & 0 & {M}_{3}\end{matrix} ] \cdot [ \begin{matrix}δ {f}_{1} \\ δ {f}_{2} \\ δ {f}_{3} \\ δ {l}_{1} \\ δ {l}_{2} \\ δ {l}_{3}\end{matrix} ] = [ \begin{matrix}0 \\ 0 \\ {Δ}_{G} \\ {Δ}_{1} \\ \begin{matrix}{Δ}_{2} \\ {Δ}_{3}\end{matrix}\end{matrix} ] \qquad ( 48 )$$

If the parameters cₙᵢ, cₗᵢ, and c_{αi} (i=1, 2, 3) are calculated by the equations (23) to (25), and fᵢ is replaced by nᵢ·lᵢ, then the solution of the equation (48) is:

$$\begin{matrix}δ {f}_{i} = \frac{{n}_{i}}{cos {α}_{i}} δ {S}_{i} - {n}_{i} tan {α}_{i} ( δ {h}_{P i} - δ {h}_{P ( i - 1 )} ) + \frac{{n}_{i} ( 3 {l}_{i} - 16 {r}_{i} )}{16 \cdot {\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} - tan {α}_{k} ) \cdot δ {h}_{Pk} - {Δ}_{G} ] & ( 49 ) \\ δ {l}_{i} = \frac{δ {S}_{i}}{cos {α}_{i}} - tan {α}_{i} ( δ {h}_{P i} - δ {h}_{P ( i - 1 )} ) - \frac{{r}_{i}}{{\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} - tan {α}_{k} ) \cdot δ {h}_{Pk} - {Δ}_{G} ] & ( 50 )\end{matrix}$$

The above analysis method for the temperature deformation of the two-tower suspension bridge can be extended to other cable systems with any number of spans (multi-span suspension bridges, transmission lines, ropeways, etc.). The multi-span cable system in FIG. 3 has u spans numbered as 1, 2, . . . , u−1, u and contains u+1 supports (including both ends) numbered as 0, 1, . . . , u−1, u, and u≥1.

Similar to the equation (2), for each span cable, the following equations are obtained:

$$\frac{δ {f}_{i}}{{f}_{i}} - \frac{δ {l}_{i}}{{l}_{i}} = - \frac{δ {H}_{i}}{{H}_{i}} \\ ( i = 1 , 2 , … , u - 1 , u ) \qquad ( 51 )$$

It is assumed that the horizontal tension equilibrium at the tower top is always maintained, that is,

$$\frac{δ {H}_{1}}{{H}_{1}} = \frac{δ {H}_{2}}{{H}_{2}} = … = \frac{δ {H}_{u}}{{H}_{u}} \qquad ( 52 )$$

According to the equations (51) and (52), u−1 equations can be obtained as follows:

$$\frac{δ {f}_{i}}{{f}_{i}} - \frac{δ {l}_{i}}{{l}_{i}} = \frac{δ {f}_{i + 1}}{{f}_{i + 1}} - \frac{δ {l}_{i + 1}}{{l}_{i + 1}} \qquad ( 53 )$$

The horizontal distance between the anchorages at both ends of the cable system is unchanged:

$${\sum }_{i = 1}^{u} δ {l}_{i} = 0 \qquad ( 54 )$$

The length Sᵢ of each span cable is as follows:

$${S}_{i} = {l}_{i} [ sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ] \qquad ( 55 )$$

where nᵢ is the sag-to-span ratio of the i^{th} span main cable:

$${n}_{i} = \frac{{f}_{i}}{{l}_{i}} \qquad ( 56 )$$

Differentiating the equation (55) yields:

δSᵢ=cₙᵢ·δnᵢ+cₗᵢ·δlᵢ+c_{αi}·δαᵢ (57)

where the coefficients cₙᵢ, cₗᵢ, and cₗᵢ are respectively:

$$\begin{matrix}{c}_{ni} = {l}_{i} \cdot [ \frac{16}{3} {n}_{i} {cos}^{3} {α}_{i} - \frac{128}{5} {n}_{i}^{3} ( 5 {cos}^{7} {α}_{i} - 4 {cos}^{5} {α}_{i} ) ] & ( 58 ) \\ {c}_{li} = sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) & ( 59 ) \\ {c}_{α i} = {l}_{i} \cdot [ \frac{sin {α}_{i}}{{cos}^{2} {α}_{i}} - 8 {n}_{i}^{2} sin {α}_{i} {cos}^{2} {α}_{i} + 32 {n}_{i}^{4} {cos}^{4} {α}_{i} sin {α}_{i} ( 7 {cos}^{2} {α}_{i} - 4 ) ] & ( 60 )\end{matrix}$$

Differentiating the equation (56) with respect to fᵢ and lᵢ leads to:

$$δ {n}_{l} = δ ( \frac{{f}_{i}}{{l}_{i}} ) = \frac{{l}_{i} \cdot δ {f}_{i} - {f}_{i} \cdot δ {l}_{i}}{{l}_{i}^{2}} \qquad ( 61 )$$

The elevation difference hᵢ between the two end supports of each span cable is:

hᵢ=lᵢ·tan αᵢ (62)

By differentiating the equation (62) with respect to lᵢ and αᵢ, the following equation is obtained:

δhᵢ=δlᵢ·tan αᵢ+lᵢ·sec²αᵢ·δαᵢ (63)

The variation of hᵢ in the above equation is equal to the difference of the elevation changes at two end supports of the i^{th} span cable:

δhᵢ=δh_{Pi}−δh_{P(i-1)} (64)

where δh_{P0} and δh_{Pu} correspond to the elevation variations of the anchorages at both ends, which are always equal to zero.

By substituting the equation (64) into the equation (63), Sa is obtained:

$$δ {α}_{i} = - \frac{sin 2 {α}_{i}}{2 \cdot {l}_{i}} \cdot δ {l}_{i} + \frac{{cos}^{2} {α}_{i}}{{l}_{i}} ( δ {h}_{Pi} - δ {h}_{P ( i - 1 )} ) \qquad ( 65 )$$

By substituting the equations (61) and (65) into the equation (57), u equations can be obtained:

$$\frac{{c}_{ni}}{{l}_{i}} \cdot δ {f}_{i} - \frac{{c}_{ni} \cdot {n}_{i}}{{l}_{i}} \cdot δ {l}_{i} + {c}_{li} \cdot δ {l}_{i} - \frac{{c}_{α i} \cdot sin 2 {α}_{i}}{2 \cdot {l}_{i}} \cdot δ {l}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} ) \qquad ( 66 )$$

It is noted that the equations (53), (54), and (66) constitute a linear system of equations with 2u unknowns δfᵢ and δlᵢ (i=1, 2, . . . , u):

$$[ \begin{matrix}{A}_{( u - 1 ) \times u} & {B}_{( u - 1 ) \times u} \\ {0}_{1 \times u} & {1}_{1 \times u} \\ {C}_{u \times u} & {D}_{u \times u}\end{matrix} ] \cdot [ \begin{matrix}δ {F}_{u \times 1} \\ δ {L}_{u \times 1}\end{matrix} ] = [ \begin{matrix}{0}_{u \times 1} \\ {Δ}_{u \times 1}\end{matrix} ] \qquad ( 67 )$$

where A, B, C, D, 0, 1, δF, δL, Δ represent a matrix or a vector, and the subscript represents the size of the matrix or vector. The elements of matrix A, B, C, D are as follows:

$$\begin{matrix}{A}_{ij} = \{ \begin{matrix}- 1 / {f}_{i} when i = j \\ 1 / {f}_{j} when i + 1 = j \\ 0 others ( i = 1 , 2 , ⋯ , u - 1 ; j = 1 , 2 , ⋯ , u ) \end{matrix} & ( 68 ) \\ {B}_{ij} = \{ \begin{matrix}1 / {l}_{i} when i = j \\ - 1 / {l}_{j} when i + 1 = j \\ 0 others ( i = 1 , 2 , ⋯ , u - 1 ; j = 1 , 2 , ⋯ , u ) \end{matrix} & ( 69 ) \\ {C}_{ij} = \{ \begin{matrix}{c}_{ni} / {l}_{i} when i = j \\ 0 others ( i = 1 , 2 , ⋯ , u ; j = 1 , 2 , ⋯ , u ) \end{matrix} & ( 70 ) \\ {D}_{ij} = \{ \begin{matrix}{M}_{i} when i = j \\ 0 others ( i = 1 , 2 , ⋯ , u ; j = 1 , 2 , ⋯ , u ) \end{matrix} \\ where & ( 71 ) \\ {M}_{i} = \frac{{c}_{ni} \cdot {n}_{i}}{{l}_{i}} + {c}_{li} - \frac{{c}_{α i} \cdot sin 2 {α}_{i}}{2 \cdot {l}_{i}} & ( 72 )\end{matrix}$$

0 or 1 represent a vector with all elements being 0 or 1. For example, 0_{1×u} is a 1-by-u vector of zeros, and 1_{1×u} is a 1-by-u vector of ones. The remaining vectors are:

δF_{u×1}=[δf₁δf₂ . . . δfᵤ]^{T} (73)

δL_{u×1}=[δl₁δl₂ . . . δlᵤ]^{T} (74)

Δ_{u×1}=[Δ₁Δ₂Δᵤ]^{T} (75)

where

$${Δ}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} ) \qquad ( 76 )$$

δSᵢ in Δᵢ is the length variation of the i^{th} span main cable caused by temperature variations. When the elastic deformation caused by the thermal stress is ignored, the length variation of the main cable can be estimated by the one-dimensional thermal expansion and contraction calculation formula as follows:

$$δ {S}_{i} = {S}_{i} \cdot {θ}_{c} \cdot δ {T}_{c} = {l}_{i} \cdot {θ}_{c} \cdot δ {T}_{c} [ sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ] \qquad ( 77 )$$

where θ_{C} and δT_{C} are respectively the linear expansion coefficient and the temperature variation of the main cable.

δh_{Pi} in Δᵢ is the elevation variation of the supports of the cable system, and Δh_{P0}=δh_{Pu}=0. When the elastic deformation of the tower is ignored, δh_{Pi} can be estimated by the following equation:

δh_{Pi}=h_{Pi}·θ_{P}·δT_{P} (78)

where θ_{P} and δT_{P} are the linear expansion coefficient and the temperature variation of the tower, respectively, and h_{Pi} is the height of the tower.

In a specific application, the main span of a two-tower ground-anchored suspension bridge is l₂=1990.796 m, and the spans of the left and right side span cables are l₁=959.999 m and l₃=960.295 m, respectively. Therefore, the horizontal distances between the two anchorages is L=3911.090 m. The sag-to-span ratios of the left side span, main span, and right side span cables are n₁=1/21.55, n₂=10.22, and n₃=1/21.83; both towers are of the same height h_{P1}=h_{P2}=287.2 m; the chord inclinations of the left side span, main span, and right side span cables are α₁=14.3°, α₂=0, and α₃=14.3°; the elevation difference of the supports of each span cable is taken as h₁=245.159 m, h₂=0.289 m, and h₃=244.785 m; and the linear expansion coefficients of the steel main cable and the steel tower are θ_{C}=1.2×10⁻⁵/° C. and θ_{P}1.2×10⁻⁵/° C., respectively.

Based on the field measurement from 2016 to 2018, the fitted sensitivity coefficient of the mid-span elevation of the main span cable with respect to the cable temperature variation is 0.07274° C. As a matter of experience, the temperature change of the tower is close to that of the main cable on the annual cycle, so δT_{P}=δT_{C}=1° C. is assumed. The relevant parameters of the case bridge are substituted into the equation (46), wherein δf₂ is calculated according to the equation (27). As a result, the calculated sensitivity coefficient of the mid-span elevation of the main span cable with the cable temperature is 0.07084° C., which is very close to the measured value with a relative error of about 2.5%. If the mid-span elevation variation of the main span cable is based on the equation (46) with δf₂ estimated by the most simplified equation (40), then the thermal sensitivity coefficient is −0.07494° C., which is still close to the fitted slope of the measured data.

It is worth noting that the traditional physics-based formulas have a significant calculation error compared with the present method. If only the thermal deformation of the main span cable is considered, the calculated sensitivity coefficient is only −0.03954° C.; meanwhile, if the sags of the side span cables are ignored, the calculated sensitivity coefficient is −0.08504° C. The relative errors of these two traditional calculation methods are approximately 46% and 17%, respectively, which indicate that the sag effects of the main span and side span cables should be taken into consideration in order to better estimate the thermal deformation of the suspension bridges with a large sag of the side span cables.

1. A method for determining a temperature-induced sag variation of a main cable and a tower-top horizontal displacement of a suspension bridge, comprising the following steps:
(1) according to an equilibrium condition, establishing the following equation:
$$\frac{δ {f}_{i}}{{f}_{i}} - \frac{δ {l}_{i}}{{l}_{i}} = \frac{δ {f}_{i + 1}}{{f}_{i + 1}} - \frac{δ {l}_{i + 1}}{{l}_{i + 1}} ;$$
where i=1, 2; fᵢ is a sag of an i^{th} span main cable; δfᵢ is a variation of fᵢ caused by a temperature variation; lᵢ is a span of the i^{th} span main cable; δlᵢ is a variation of lᵢ caused by the temperature variation and is related to the tower-top horizontal displacement; subscripts 1, 2, 3 of variables indicate a left side span, a main span, and a right side span, respectively; the equilibrium condition is that a first horizontal tension of a first cable on a first side of a tower top is equal to a second horizontal tension of a second cable on a second side of the tower top;
(2) according to a geometric relationship between a shape of the main cable and a length of the main cable, establishing the following equation:
$$\frac{{c}_{ni}}{{l}_{i}} \cdot δ {f}_{i} - \frac{{c}_{ni} \cdot {n}_{i}}{{l}_{i}} \cdot δ {l}_{i} + {c}_{li} \cdot δ {l}_{i} - \frac{{c}_{α i} \cdot sin 2 {α}_{i}}{2 \cdot {l}_{i}} \cdot δ {l}_{i} = δ {S}_{i} - \frac{{c}_{α i} \cdot {cos}^{2} {α}_{i}}{{l}_{i}} ( δ {h}_{Pi} - δ {h}_{P ( i - 1 )} ) ;$$
where i=1, 2, 3; nᵢ is a sag-to-span ratio of the i^{th} span main cable, i.e. nᵢ=fᵢ/lᵢ; αᵢ is a chord inclination of the i^{th} span main cable; coefficients cₙᵢ, cₗᵢ and c_{αi} are respectively:
$${c}_{ni} = {l}_{i} \cdot [ \frac{16}{3} {n}_{i} {cos}^{3} {α}_{i} - \frac{128}{5} {n}_{i}^{3} ( 5 {cos}^{7} {α}_{i} - 4 {cos}^{5} {α}_{i} ) ] ;$$
$${c}_{li} = sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ;$$
$${c}_{α i} = {l}_{i} \cdot [ \frac{sin {α}_{i}}{{cos}^{2} {α}_{i}} - 8 {n}_{i}^{2} sin {α}_{i} {cos}^{2} {α}_{i} + 32 {n}_{i}^{4} {cos}^{4} {α}_{i} sin {α}_{i} ( 7 {cos}^{2} {α}_{i} - 4 ) ] ;$$
δSᵢ is a length variation of the i^{th} span main cable caused by the temperature variation; δh_{Pi} is an elevation variation of a support i of the main cable, δh_{P(i-1)} is an elevation variation of a support i−1 of the main cable; since a position of a first anchorage and a position of a second anchorage are unchanged, δh_{P0}=δh_{P3}=0; δh_{P1} corresponds to a height variation of a left tower of the suspension bridge, and δh_{P2} corresponds to a height variation of a right tower of the suspension bridge;
δSᵢ (i=1, 2, 3) and δh_{Pi} (i=1, 2) are estimated by the following equations:
$$δ {S}_{i} = {S}_{i} \cdot {θ}_{c} \cdot δ {T}_{c} = {l}_{i} \cdot {θ}_{c} \cdot δ {T}_{c} [ sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ] ; δ {h}_{Pi} = {h}_{Pi} \cdot {θ}_{P} \cdot δ {T}_{P} ;$$
where θ_{C} is a linear expansion coefficient of the main cable, θ_{P} is a linear expansion coefficient of a tower of the suspension bridge, δT_{C} is a temperature variation of the main cable, δT_{P} is a temperature variation of the tower of the suspension bridge, and h_{Pi} is a height of the tower of the suspension bridge;
(3) according to a compatibility condition to be satisfied by a sum of spans of a left side span cable, a main span cable, and a right side span cable, establishing the following equation:
$${\sum }_{i = 1}^{3} δ {l}_{i} = 0 ;$$
where in the compatibility condition is that a distance between the first anchorage and the second anchorage is constant, where in the first anchorage is located at a left end of the main cable of the suspension bridge, while the second anchorage is located at a right end of the main cable of the suspension bridge; and
(4) according to the following linear system of equations consisting of the equations in step (1), step (2), and step (3), simultaneously obtaining the sag variation δfᵢ and the span variation δlᵢ of each of the left side span cable, the main span cable, and the right side span cable:
$$[ \begin{matrix}- \frac{1}{{f}_{1}} & \frac{1}{{f}_{2}} & 0 & \frac{1}{{l}_{1}} & - \frac{1}{{l}_{2}} & 0 \\ 0 & - \frac{1}{{f}_{2}} & \frac{1}{{f}_{3}} & 0 & \frac{1}{{l}_{2}} & \frac{1}{{l}_{3}} \\ 0 & 0 & 0 & 1 & 1 & 1 \\ \frac{{c}_{n 1}}{{l}_{1}} & 0 & 0 & {M}_{1} & 0 & 0 \\ 0 & \frac{{c}_{n 2}}{{l}_{2}} & 0 & 0 & {M}_{2} & 0 \\ 0 & 0 & \frac{{c}_{n 3}}{{l}_{3}} & 0 & 0 & {M}_{3}\end{matrix} ] \cdot [ \begin{matrix}δ {f}_{1} \\ δ {f}_{2} \\ δ {f}_{3} \\ δ {l}_{1} \\ δ {l}_{2} \\ δ {l}_{3}\end{matrix} ] = [ \begin{matrix}0 \\ 0 \\ 0 \\ {Δ}_{1} \\ {Δ}_{2} \\ {Δ}_{3}\end{matrix} ] ;$$
$$where {M}_{i} = - \frac{{c}_{ni} \cdot {n}_{i}}{{l}_{i}} + {c}_{li} - \frac{{c}_{α i} \cdot sin 2 {α}_{i}}{2 \cdot {l}_{i}} , \\ {Δ}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} ) , i = 1 , 2 , 3.$$

2. The method for determining the temperature-induced sag variation of the main cable and the tower-top horizontal displacement of the suspension bridge according to claim 1, where in, the suspension bridge comprises a two-tower ground-anchored suspension bridge.

3. The method for determining the temperature-induced sag variation of the main cable and the tower-top horizontal displacement of the suspension bridge according to claim 1, where in, when a plurality of higher-order terms of the sag-to-span ratio nᵢ in the coefficients cₙᵢ, cₗᵢ, and c_{αi} are ignored, analytical solutions of the sag variation δfᵢ and the span variation δlᵢ of each of the left side span cable, the main span cable, and the right side span cable are respectively:
$$δ {f}_{i} = \frac{{n}_{i}}{cos {α}_{i}} δ {S}_{i} - {n}_{i} tan {α}_{i} ( δ {h}_{Pi} - δ {h}_{p ( i - 1 )} ) + \frac{{n}_{i} ( 3 {l}_{i} - 16 {r}_{i} )}{16 \cdot {\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} - tan {α}_{k} ) \cdot δ {h}_{Pk} ] ;$$
$$δ {l}_{i} = \frac{δ {S}_{i}}{cos {α}_{i}} tan {α}_{i} ( δ {h}_{Pi} - δ {h}_{p ( i - 1 )} ) - \frac{ {r}_{i}}{{\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} - tan {α}_{k} ) \cdot δ {h}_{Pk} ] ;$$
where rᵢ=lᵢ·nᵢ²·cos²αᵢ (i=1, 2, 3), rⱼ=lⱼ·nⱼ²·cos²αⱼ (j=1, 2, 3), and i, j, and k are all subscripts.

4. The method for determining the temperature-induced sag variation of the main cable and the tower-top horizontal displacement of the suspension bridge according to claim 3, where in, when a tower top of the left tower and a tower top of the right tower are at a same elevation, i.e. α₂=0, and conditions of α₁>0, α₃<0, h_{P1}≈h₁, h_{P2}≈|h₃|, θ_{C}·δT_{C}≈θ_{P}·δT_{P} are satisfied, the sag variation δf₂ of the main span cable is estimated by the following equation:
$$δ {f}_{2} = \frac{{r}_{2}}{{\sum }_{j = 1}^{3} {r}_{j}} \cdot \frac{3 {θ}_{C} \cdot δ {T}_{C}}{16 {n}_{2}} {\sum }_{i = 1}^{3} {l}_{i} ;$$
when a sag of the left side span cable and a sag of the right side span cable of the suspension bridge are further ignored, the above equation is simplified as:
$$δ {f}_{2} = \frac{3 {θ}_{C} \cdot δ {T}_{C}}{16 {n}_{2}} {\sum }_{i = 1}^{3} {l}_{i} .$$

5. The method for determining the temperature-induced sag variation of the main cable and the tower-top horizontal displacement of the suspension bridge according to claim 3, where in, when both tower tops are at the same elevation, i.e. α₂=0, and the sag of the left side span cable and the sag of the right side span cable are not considered, i.e. r₁=r₃=0, and conditions of α₁>0, α₃<0, h_{P1}≈h₁, h_{P2}≈|h₃|, θ_{C}·δT_{C}≈θ_{P}·δT_{P} are satisfied, a tower-top horizontal displacement δlᵢ of the left tower, a tower-top horizontal displacement δl₃ of the right tower and a tower-top horizontal distance variation δl₂ are calculated by the following equations:
δl₁=l₁θ_{C}·δT_{C};
δl₂=−(l₁+l₃)θ_{C}·δT_{C};
δl₃=l₃θ_{C}·δT_{C}.

6. The method for determining the temperature-induced sag variation of the main cable and the tower-top horizontal displacement of the suspension bridge according to claim 1, where in, when a cable system comprises u spans numbered as 1, 2, . . . , u−1, u and u+1 supports numbered as 0, 1, . . . , u−1, u where in u≥1, and the u+1 supports comprise a first anchorage at a first end of the cable system and a second anchorage at a second end of the cable system; a calculation method for a temperature-induced sag variation of a main cable and a tower-top horizontal displacement of a multi-span suspension bridge is as follows:
(1) according to the equilibrium condition, establishing the following u−1 equations:
$$\frac{δ {f}_{i}}{{f}_{i}} - \frac{δ {l}_{i}}{{l}_{i}} = \frac{δ {f}_{i + 1}}{{f}_{i + 1}} - \frac{δ {l}_{i + 1}}{{l}_{i + 1}} ;$$
where i=1, 2, . . . , u−1; fᵢ is the sag of the i^{th} span main cable; δfᵢ is the variation of fᵢ caused by the temperature variation; lᵢ is the span of the i^{th} span main cable; δlᵢ is the variation of lᵢ caused by the temperature variation; the equilibrium condition is that the first horizontal tension of the first cable on the first side of the tower top is equal to the second horizontal tension of the second cable on the second side of the tower top;
(2) according to the geometric relationship between the shape of the main cable and the length of the main cable, establishing the following u equations:
$$\frac{{c}_{ni}}{{l}_{i}} \cdot δ {f}_{i} - \frac{{c}_{ni} \cdot {n}_{i}}{{l}_{i}} \cdot δ {l}_{i} + {c}_{li} \cdot δ {l}_{i} - \frac{{c}_{α i} \cdot sin 2 {α}_{i}}{2 \cdot {l}_{i}} \cdot δ {l}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} ) ;$$
where i=1, 2, . . . , u; nᵢ is the sag-to-span ratio of the i^{th} span main cable, i.e. nᵢ=fᵢ/lᵢ; αᵢ is the chord inclination of the i^{th} span main cable; the coefficients cₙᵢ, cₗᵢ, and c_{αi} are respectively:
$${c}_{n i} = {l}_{i} \cdot [ \frac{16}{3} {n}_{i} {cos}^{3} {α}_{i} - \frac{128}{5} {n}_{i}^{3} ( 5 {cos}^{7} {α}_{i} - 4 {cos}^{5} {α}_{i} ) ] ;$$
$${c}_{l i} = sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ;$$
$${c}_{α i} = {l}_{1} \cdot [ \frac{sin {α}_{i}}{{cos}^{2} {α}_{1}} - 8 {n}_{i}^{2} sin {α}_{i} {cos}^{2} {α}_{i} + 32 {n}_{i}^{4} {cos}^{4} {α}_{i} {α}_{i} ( 7 {cos}^{2} {α}_{i} - 4 ) ] ;$$
δSᵢ is the length variation of the i^{th} span main cable caused by the temperature variation; δh_{Pi} is an elevation variation of intermediate supports (tower tops), i=1, 2, . . . , u−1, and δh_{P0}=δh_{Pu}=0; and δSᵢ and δh_{Pi} are calculated according to the following equations:
$$δ {S}_{i} = {S}_{i} \cdot {θ}_{C} \cdot δ {T}_{C} = {l}_{i} \cdot {θ}_{C} \cdot δ {T}_{C} [ sec {α}_{i} + \frac{8}{3} {n}_{i}^{2} {cos}^{3} {α}_{i} - \frac{32}{5} {n}_{i}^{4} ( 5 {cos}^{7} {α}_{i} - 4 {cos}^{5} {α}_{i} ) ] ;$$
$$δ {h}_{Pi} = {h}_{Pi} \cdot {θ}_{P} \cdot δ {T}_{P} ;$$
where θ_{C} is the linear expansion coefficient of the main cable, θ_{P} is the linear expansion coefficient of the tower of the suspension bridge, δT_{C} is the temperature variation of the main cable, δT_{P} is the temperature variation of the tower of the suspension bridge, and h_{Pi} is the height of the tower of the suspension bridge;
(3) according to the compatibility condition to be satisfied by the sum of all spans of the main cable, the following equation is established:
$${\sum }_{i = 1}^{u} δ {l}_{i} = 0 ;$$
where in the compatibility condition is that the distance between the first anchorage and the second anchorage is constant, where in the first anchorage is located at the left end of the main cable of the suspension bridge, while the second anchorage is located at the right end of the main cable of the suspension bridge; and
(4) according to the linear system of equations consisting of the above equations in steps (1), (2), and (3), simultaneously obtaining the sag variation δfᵢ and the span variation δlᵢ of each span of the main cable:
$$[ \begin{matrix}{A}_{( u - 1 ) \times u} & {B}_{( u - 1 ) \times u} \\ {0}_{1 \times u} & {1}_{1 \times u} \\ {C}_{u \times u} & {D}_{u \times u}\end{matrix} ] \cdot [ \begin{matrix}δ {F}_{u \times 1} \\ δ {L}_{u \times 1}\end{matrix} ] = [ \begin{matrix}{0}_{u \times 1} \\ {Δ}_{u \times 1}\end{matrix} ] ;$$
where A, B, C, D, 0, 1, δF, δL, Δ represent a matrix or a vector, and a subscript represents a size of the matrix or vector; elements in matrix A, B, C, D are as follows:
$${A}_{ij} = \{ \begin{matrix}- 1 / {f}_{i} & when i = j \\ 1 / {f}_{j} & when i + 1 = j \\ 0 & others\end{matrix} , \\ i = 1 , 2 , … , u - 1 ; j = 1 , 2 , … , u ; \\ {B}_{ij} = \{ \begin{matrix}1 / {l}_{i} & when i = j \\ - 1 / {l}_{j} & when i + 1 = j \\ 0 & others\end{matrix} , \\ i = 1 , 2 , … , u - 1 ; j = 1 , 2 , … , u ; \\ {C}_{ij} = \{ \begin{matrix}{c}_{ni} / {l}_{i} & when i = j \\ 0 & others\end{matrix} , \\ i = 1 , 2 , … , u ; j = 1 , 2 , … , u ; \\ {D}_{ij} = \{ \begin{matrix}{M}_{i} & when i = j \\ 0 & others\end{matrix} , \\ i = 1 , 2 , … , u ; j = 1 , 2 , … , u ; where \\ {M}_{i} = - \frac{{c}_{ni} \cdot {n}_{i}}{{l}_{i}} + {c}_{li} - \frac{{c}_{α i} \cdot sin 2 {α}_{i}}{2 \cdot {l}_{i}} ;$$
0 represents a vector with all elements being 0, and 1 represents a vector with all elements being 1, for example, 0_{1×u} is a 1-by-u vector of zeros, and 1_{1×u} is a 1-by-u vector of ones; remaining vectors are:
$$δ {F}_{u \times 1} = {[ δ {f}_{1} δ {f}_{2} … δ {f}_{u} ]}^{T} ;$$
$$δ {L}_{u \times 1} = {[ δ {l}_{1} δ {l}_{2} … δ {l}_{u} ]}^{T} ;$$
$${Δ}_{u \times 1} = {[ {Δ}_{1} {Δ}_{2} … {Δ}_{u} ]}^{T} ; where$$
$${Δ}_{i} = δ {S}_{i} - \frac{{c}_{α i} \cdot {cos}^{2} {α}_{i}}{{l}_{i}} \cdot ( δ {h}_{Pi} - δ {h}_{P ( i - 1 )} )$$

7. The method for determining the temperature-induced sag variation of the main cable and the tower-top horizontal displacement of suspension bridges according to claim 1, where in, when the suspension bridge is a two-tower self-anchored suspension bridge, and the plurality of higher-order terms of the sag-to-span ratio nᵢ in the coefficients cₙᵢ, cₗᵢ, and c_{αi} are ignored, the analytical solutions of the sag variation δfᵢ and the span variation of δlᵢ each span of the main cable are respectively:
$$δ {f}_{i} = \frac{{n}_{i}}{cos {α}_{i}} δ {S}_{i} - {n}_{i} tan {α}_{i} ( δ {h}_{Pi} - δ {h}_{P ( i - 1 )} ) + \frac{{n}_{i} ( 3 {l}_{i} - 16 {r}_{i} )}{16 \cdot {\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} - tan {α}_{k} ) \cdot δ {h}_{Pk} - {Δ}_{G} ] ;$$
$$δ {l}_{i} = \frac{δ {S}_{i}}{cos {α}_{i}} - tan {α}_{i} ( δ {h}_{Pi} - δ {h}_{p ( i - 1 )} ) - \frac{ {r}_{i}}{{\sum }_{j = 1}^{3} {r}_{j}} [ {\sum }_{k = 1}^{3} \frac{δ {S}_{k}}{cos {α}_{k}} + {\sum }_{k = 1}^{2} ( tan {α}_{k + 1} - tan {α}_{k} ) \cdot δ {h}_{Pk} - {Δ}_{G} ] ;$$
where, Δ_{G} is a horizontal distance variation between anchored points of the main cable on a main girder, and when the main girder is continuous, Δ_{G}=L_{G}θ_{G}·δT_{G};
where L_{G} is a total length of the main girder, θ_{G} is a linear expansion coefficient of the main girder, and δT_{G} is a temperature variation of the main girder.

8. The method for determining the temperature-induced sag variation of the main cable and the tower-top horizontal displacement of suspension bridges according to claim 1, where in, when the suspension bridge is a two-tower suspension bridge, a mid-span elevation variation δD₂ of the main span cable is estimated from the sag variation of the main span cable of the suspension bridge as follows:
$$δ {D}_{2} = - δ {f}_{2} + \frac{{h}_{P 1} + {h}_{P 2}}{2} \cdot {θ}_{P} \cdot δ {T}_{P} .$$
